(19) United States
(12) Patent Application Publication
(10) Pub. No.: US 2022/0318837 A1
(43) Pub. Date: Oct. 6, 2022

(54) INFORMATION PROCESSING APPARATUS AND INFORMATION PROCESSING SYSTEM

(71) Applicant: TOYOTA JIDOSHA KABUSHIKI KAISHA, Toyota-shi Aichi-ken (JP)

(72) Inventors: Kensaku Shibata, Toyota-shi Aichi-ken (JP); Ryo Murakami, Susono-shi Shizuoka-ken (JP); Shinnosuke Shimokawa, Susono-shi Shizuoka-ken (JP); Junichi Mori, Nagakute-shi Aichi-ken (JP); Sokfan Yee, Toyota-shi Aichi-ken (JP); Yuta Maniwa, Susono-shi Shizuoka-ken (JP)

(21) Appl. No.: 17/705,610

(22) Filed: Mar. 28, 2022

(30) Foreign Application Priority Data
Apr. 6, 2021 (JP) 2021-064742

(51) Int. Cl. G06Q 30/02; G06V 20/59; G06V 40/10

(52) U.S. Cl. CPC G06Q 30/0226; G06V 20/59; G06V 40/103

(57) ABSTRACT

An information processing apparatus includes a receiving unit that receives authentication information for authenticating a passenger in a vehicle, an authentication unit that authenticates a passenger based on the authentication information, an assessment unit that assesses whether the authenticated passenger is standing up, a measuring unit that measures a period of time during which it is assessed that the authenticated passenger is standing up as a period of time during which the passenger is actually standing up, a calculation unit that calculates points or digital currency used in a reward program such that the authenticated passenger who stands up for a longer period of time gets more points or a higher amount of digital currency, and a transmission unit that transmits the calculated points or digital currency to a storage unit. The storage unit is configured to store the points or the digital currency in association with the passenger.

### CROSS-REFERENCE TO RELATED APPLICATION

This application claims priority to Japanese Patent Application No. 2021-064742 filed on Apr. 6, 2021, incorporated herein by reference in its entirety.

### BACKGROUND

### 1. Technical Field

The present disclosure relates to an information processing apparatus and to an information processing system.

### 2. Description of Related Art

A non-contact IC card reader is provided on a holding member of a strap handle installed in a vehicle, and a passenger brings a non-contact IC card into contact with the reader to import, for example, product information and advertiser information into the non-contact IC card (refer to, for example, Japanese Unexamined Patent Application Publication No. 2009-014821).

### SUMMARY

Recently, reduced walking opportunities due to developed and innovative transportation have led to modern citizens having a lack of physical activity. On the other hand, public transport (e.g. trains and buses) fails to provide passengers with benefits other than transportation.

From the viewpoint of overcoming this lack of physical activity, passengers in a vehicle can burn more calories by standing instead of sitting in seats. However, currently there is no mechanism for increasing passengers' motivation to stand in a vehicle.

The present disclosure provides an information processing apparatus and an information processing system, which are capable of encouraging passengers to stand up in a vehicle.

An information processing apparatus according to a first aspect of the present disclosure includes a receiving unit configured to receive authentication information for authenticating a passenger in a vehicle, an authentication unit configured to authenticate a passenger based on the authentication information, an assessment unit configured to assess whether the authenticated passenger is standing up, a measuring unit configured to measure a period of time during which the assessment unit assesses that the authenticated passenger is standing up as a period of time during which the passenger is actually standing up, a calculation unit configured to calculate points or digital currency used in a reward program, and a transmission unit configured to transmit the calculated points or digital currency to a storage unit. The calculation unit calculates the points or the digital currency such that an authenticated passenger who stands up for a longer period of time gets more points or a higher amount of digital currency. The storage unit is configured to store the points or the digital currency in association with the passenger.

In the first aspect, the receiving unit may receive the authentication information from an authentication device installed inside the vehicle. The authentication device is configured to authenticate the passenger. The information processing apparatus may further include an image acquisition unit configured to acquire an image taken in the vicinity of the authentication device. The assessment unit may assess that the authenticated passenger is standing up in a case where the image shows the passenger standing up within a predetermined range of distance from the authentication device.

In the first aspect, the receiving unit may receive the authentication information from an authentication device installed inside the vehicle and establishing short-range wireless communication with a communication device. The communication device is owned by the passenger and includes the storage unit. The authentication unit may authenticate the passenger by verifying the authentication information stored in the communication device. The transmission unit may transmit the calculated points or digital currency to the storage unit of the communication device.

In the first aspect, the information processing apparatus may further include a determination unit configured to determine whether the communication device is in a communicable state with and is close to the authentication device installed at a height at which the passenger is able to bring the passenger's hands closer to the authentication device when the passenger stands up in the vehicle. The assessment unit may assess that the authenticated passenger is standing up in a case where the communication device is in a communicable state with and is close to the authentication device.

In the first aspect, the information processing apparatus may further include an image acquisition unit configured to acquire an image taken in a vicinity of the authentication device. The assessment unit may assess that the authenticated passenger is standing up in a case where the image shows the passenger standing up within a predetermined range of distance from the authentication device.

In the first aspect, the information processing apparatus may further include a determination unit configured to determine whether the communication device is in a communicable state with and is close to the authentication device installed at a height at which the passenger is able to bring the passenger's hands closer to the authentication device when the passenger stands up in the vehicle. The assessment unit may assess that the authenticated passenger is standing up in a case where the communication device is in a communicable state with and is close to the authentication device and the image shows the passenger standing up within the predetermined range of distance from the authentication device.

In the first aspect, the communication device may be an IC card or a portable terminal.

In the first aspect, the authentication device may be a biometric information acquisition device that acquires biometric information of the passenger. The authentication information may be the biometric information of the passenger acquired by the biometric information acquisition device. The authentication unit may authenticate the passenger based on the biometric information.

In the first aspect, the receiving unit may receive the authentication information from an authentication device installed inside the vehicle. The authentication device is configured to authenticate the passenger. The authentication device may be a biometric information acquisition device that acquires biometric information of the passenger. The authentication information may be the biometric information of the passenger acquired by the biometric information acquisition device. The authentication unit may authenticate the passenger based on the biometric information. The assessment unit may be provided in a vicinity of the biometric information acquisition device and may assess whether the authenticated passenger is standing up based on an output from a touch sensor installed at a height at which the passenger is able to bring the passenger's hands closer to the authentication device when the passenger stands up.

In the first aspect, the transmission unit may transmit points or digital currency in association with the authenticated passenger to the storage unit which is configured to store points or digital currency in association with each of a plurality of passengers, based on the authentication information.

In the first aspect, the authentication device may be provided on a strap handle in the vehicle.

An information processing system according to a second aspect of the present disclosure includes a communication device owned by a passenger in a vehicle and an information processing apparatus connected to and wirelessly communicating with the communication device. The information processing system includes a receiving unit configured to receive authentication information for authenticating a passenger in the vehicle, an authentication unit configured to authenticate a passenger based on the authentication information, an assessment unit configured to assess whether the authenticated passenger is standing up, a measuring unit configured to measure a period of time during which the assessment unit assesses that the authenticated passenger is standing up as a period of time during which the passenger is actually standing up, a calculation unit configured to calculate points or digital currency used in a reward program, and a transmission unit configured to transmit the calculated points or digital currency to a storage unit of the communication device. The calculation unit calculates the points or digital currency such that the authenticated passenger who stands up for a longer period of time gets more points or a higher amount of digital currency. The storage unit is configured to store the points or the digital currency in association with the passenger.

With each aspect of the present disclosure, it is possible to provide an information processing apparatus and an information processing system, which are capable of encouraging passengers to stand up in a vehicle.

### BRIEF DESCRIPTION OF THE DRAWINGS

Features, advantages, and technical and industrial significance of exemplary embodiments of the present disclosure will be described below with reference to the accompanying drawings, in which like signs denote like elements, and wherein:

FIG. 1 is a schematic view illustrating the inside of a vehicle provided with a strap handle and a point reward device according to a first embodiment of the present disclosure;

FIG. 2 is a schematic view illustrating enlarged views of the strap handle, the point reward device, and periphery thereof;

FIG. 3 is a block diagram illustrating a hardware configuration of a system configured by the point reward device and an IC card;

FIG. 4 is a schematic view illustrating functional blocks of a control unit provided in the point reward device;

FIG. 5 is a sequence diagram illustrating a process executed by the system configured by the point reward device and the IC card;

FIG. 6 is a schematic view illustrating the inside of the vehicle provided with the strap handle and the point reward device according to a second embodiment of the present disclosure;

FIG. 7 is a block diagram illustrating a hardware configuration of the system configured by the point reward device and the IC card according to the second embodiment;

FIG. 8 is a schematic view illustrating functional blocks of the control unit provided in the point reward device according to the second embodiment;

FIG. 9 is a sequence diagram illustrating a process executed by the system configured by the point reward device and the IC card according to the second embodiment;

FIG. 10 is a sequence diagram illustrating a process in a case where it is assessed that a passenger who owns the authentication IC card is standing up based on both an image received from a camera and the IC card being present in the vicinity of the point reward device;

FIG. 11 is an enlarged schematic view illustrating the strap handle, the point reward device, and the periphery thereof, which shows an example in which an IC card holder is provided in the point reward device;

FIG. 12 is an enlarged schematic view illustrating the strap handle, the point reward device, and the periphery thereof, which shows an example in which a biometric information acquisition device is mounted on the strap handle together with the point reward device;

FIG. 13 is a block diagram illustrating a hardware configuration of a point reward device according to Modified Example 1, and a peripheral configuration of the point reward device;

FIG. 14 is an enlarged schematic view illustrating the strap handle, the point reward device, and the periphery thereof, which shows an example in which a touch sensor is mounted on the strap handle as well as the point reward device and the biometric information acquisition device; and

FIG. 15 is a block diagram illustrating a hardware configuration of a point reward device according to Modified Example 2, and a peripheral configuration of the point reward device.

### DETAILED DESCRIPTION OF EMBODIMENTS

Hereinafter, several embodiments of the present disclosure will be described with reference to drawings. However, these descriptions are merely intended to illustrate embodiments of the present disclosure, not to limit the present disclosure to such particular embodiments.

### First Embodiment

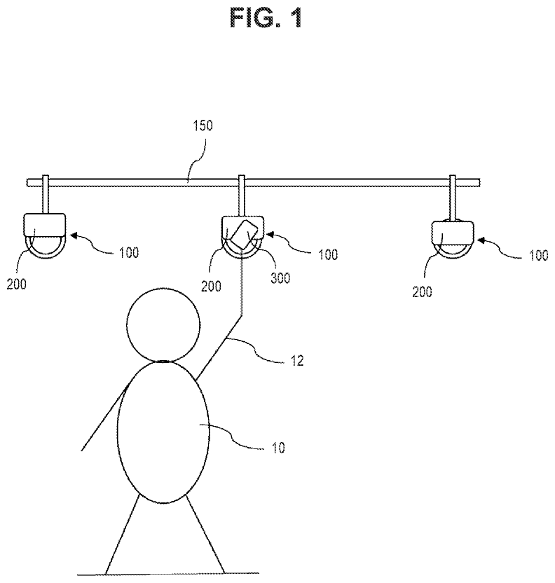

FIG. 1 is a schematic view illustrating the inside of a vehicle provided with a strap handle 100 and a point reward device 200 according to a first embodiment of the present disclosure. The strap handle 100 supports the body of a passenger 10 who is standing up in the vehicle and grabs the strap handle 100, and is provided at a height at which a typical adult passenger standing up can move their hands such that their hands are close to the strap handle, but a height at which the passenger cannot move their hands such that their hands are close to the strap handle while sitting in a seat of the vehicle. As one example, the strap handle 100 is provided on a bus which is for transporting the passenger 10 and which is traveling on a road. FIG. 1 schematically shows that a plurality of strap handles 100 are suspended from a support pipe 150 installed in the vehicle and an arm 12 of the passenger 10 grabs the middle strap handle 100 in the figure.

A point reward device 200 is attached to the strap handle 100. The passenger 10 holds an IC card 300 with a hand of the arm 12 grabbing the strap handle 100, and brings the IC card 300 close to the point reward device 200.

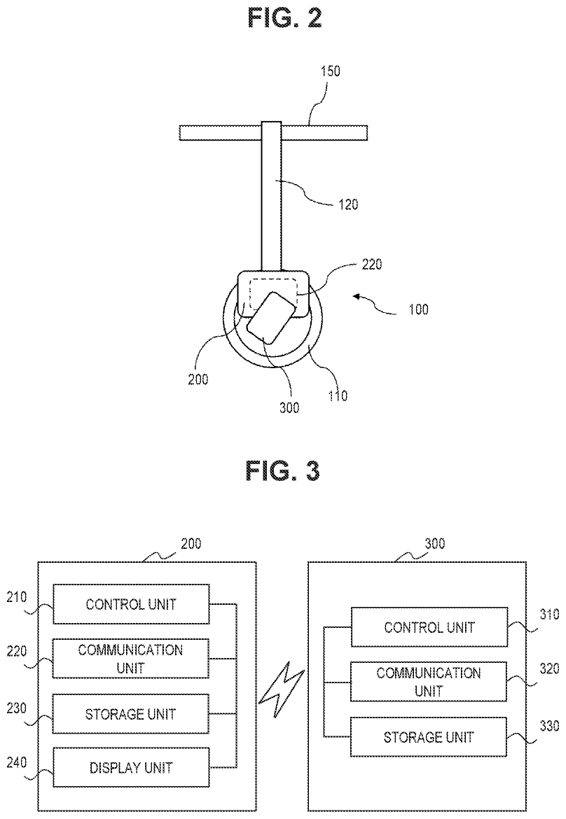

FIG. 2 is a schematic view illustrating enlarged views of the strap handle 100, the point reward device 200, and periphery thereof. The strap handle 100 is a general-purpose handle configured by having a hanging ring 110 and a connector 120. One end of the connector 120 is suspended from the support pipe 150, and the hanging ring 110 is suspended from the other end of the connector 120.

In the present embodiment, the point reward device 200 is a reader/writer, and is fixed to the hanging ring 110 or the connector 120. When the passenger 10 brings the IC card 300 close to the point reward device 200, the point reward device 200 can read out information of the IC card 300 by establishing communication with the IC card 300, and can also write information to the IC card 300.

The IC card 300 is one example of a communication device owned by the passenger, which may be, for example, an electronic commuter pass, an electronic ticket, or an e-debit card, and is capable of earning electronic reward points that can be redeemed in a reward program. In the present embodiment, when the IC card 300 approaches the point reward device 200, the card establishes communication with the point reward device 200 with or without contact. When authentication information stored in the IC card 300 is authenticated by the point reward device 200, the passenger is authenticated. While the IC card 300 is close to the point reward device 200, 300 points are transmitted from the point reward device 200 to the IC card 300 depending on a period of time during which the IC card 300 is maintained in a state of being close to the point reward device 200. In the IC card 300, the points transmitted from the point reward device 200 are added to points already stored in association with the authentication information. The passenger 10 can redeem the points stored in the IC card 300 in association with the authentication information, for example, when purchasing products at a store. The reward points may be digital currency.

In the present embodiment, the IC card 300 is illustrated as one aspect of the communication device, but instead of the IC card 300, an IC chip having the same function as the IC card 300, or any portable terminal equipped with the IC chip (e.g. IC tag, a mobile phone such as a smartphone, or a mobile information terminal such as a tablet terminal) can be used.

Since the point reward device 200 is mounted on the strap handle 100, the passenger 10 has to stand up in order for them to bring the IC card 300 close to the point reward device 200. That is, the passenger 10 needs to keep standing up without sitting in a seat of the vehicle in order to earn points on the IC card 300.

Consequently, the passenger 10 trying to earn points on the IC card 300 consumes calories and is able to overcome their lack of physical activity, thereby improving their health. Additionally, since the passenger 10 who wants to earn points on the IC card 300 stands up without sitting, a seat becomes vacant, thus allowing the elderly, people with disabilities, pregnant women, and people with injuries to have more opportunities to have a seat.

As described above, in the first embodiment, it is assessed that the passenger 10 who owns the IC card 300 is standing up in a case where the IC card 300 is close to the point reward device 200, and the points are rewarded to the IC card 300 that is close to the point reward device 200.

Although a plurality of point reward devices 200 are shown in FIG. 1, each point reward device 200 shares the same configuration for a process of rewarding points to the IC card 300. Hereinafter one point reward device 200 will be described.

FIG. 3 is a block diagram illustrating a hardware configuration of a system configured by the point reward device 200 and the IC card 300. The point reward device 200 includes a control unit 210, a communication unit 220, a storage unit 230, and a display unit 240. The control unit 210, the communication unit 220, the storage unit 230, and the display unit 240 are communicably connected to each other. Furthermore, the point reward device 200 may not have the display unit 240.

The control unit 210 of the point reward device 200 is one aspect of the information processing apparatus, and is configured by a processor. The processor includes one or more central processing units (CPUs) and peripheral circuits of the CPUs. The processor may further include another arithmetic circuit such as a logical operation unit, a numerical operation unit, or a graphic processing unit. The control unit 210 provides a function satisfying a predetermined purpose by executing a computer program that is executably deployed in a work area of the storage unit 230.

The communication unit 220 of the point reward device 200 is one aspect of the authentication device installed in the vehicle for authenticating passengers, and is a communication interface used when establishing communication with the IC card 300, which transmits and receives data to and from the IC card 300 by establishing, for example, near-field wireless communication complying with a near-field communication (NFC) protocol. As used herein, the “near-field wireless communication” refers to communication between two devices over a distance within several tens of centimeters, including communication between two devices connected via physical contact with each other (or their housings). In other words, the term “close to” used herein means that the point reward device 200 (or the communication unit 220 of the point reward device 200) and the IC card 300 are within a predetermined distance, or alternatively, they come into contact with each other.

The communication unit 220 emits a predetermined electromagnetic wave, and detects whether the IC card 300 is close to the IC card 300 based on load changes with respect to the electromagnetic wave. The communication unit 220 is configured to have an antenna (not shown) for transmitting and receiving several types of data to and from the IC card 300 when the IC card 300 is close to the point reward device 200. As shown in FIG. 2, the communication unit 220 is provided in the vicinity of a surface of a housing of the point reward device 200 in a region where passengers can easily bring the IC card 300 to the point reward device 200. For example, the communication unit 220 modulates a carrier wave having a predetermined frequency supplied from an oscillation circuit (OSC) based on data transmitted to the IC card 300, and outputs the generated modulating wave as the electromagnetic wave from the antenna. Further, the communication unit 220 demodulates the modulating wave transmitted from the IC card 300 and acquired via the antenna, and appropriately supplies the demodulated data to, for example, the control unit 210.

The communication unit 220 of the point reward device 200 may comply with the Bluetooth® protocol. In a case where the communication device owned by the passenger complies with the Bluetooth® protocol, the communication unit 220 may establish communication with the communication device via communication complying with the Bluetooth® protocol.

The storage unit 230 of the point reward device 200 includes, for example, a volatile semiconductor memory and a nonvolatile semiconductor memory. The storage unit 230 stores programs and data required for the control unit 210 to control each unit of the point reward device 200, and also stores, for example, data from the IC card 300 and data provided to the IC card 300.

The display unit 240 of the point reward device 200 is configured by, for example, a liquid crystal display (LCD), which displays values of the points transmitted to the IC card 300 as the passenger 10 brings the IC card 300 close to the point reward device 200, or values of the points stored in the IC card 300 in association with the authentication information.

Although FIGS. 1 and 2 show an example in which components of the point reward device 200 shown in FIG. 3 are mounted on the strap handle 100, a configuration may be allowable in which only the communication unit 220 of the point reward device 200 is mounted on the strap handle 100, while remaining components of the point reward device 200 are arranged elsewhere in the vehicle and communicably connected to each other via an in-vehicle network complying with a protocol such as an controller area network (CAN) or Ethernet®. Further, in a case where only the communication unit 220 is mounted on the strap handle 100, the communication unit 220 may be configured to establish communication with a server inside or outside the vehicle via a communication network such as the internet, or alternatively, the components such as the control unit 210 and the storage unit 230 of the point reward device 200 may be provided on a server side.

The IC card 300 includes a control unit 310, a communication unit 320, and a storage unit 330. The control unit 310 of the IC card 300 is configured by a processor and controls each unit of the IC card 300.

The communication unit 320 of the IC card 300 is a communication interface for establishing communication with the point reward device 200, and performs near-field communication with the communication unit 220 of the point reward device 200, complying with, for example, the NFC protocol stated above. The communication unit 320 may include an LC circuit configured by a coiled antenna and a capacitor. The LC circuit resonates with an electromagnetic wave having a predetermined frequency, which is emitted from the communication unit 220 of the point reward device 200 that the LC circuit is arranged nearby. The communication unit 320 rectifies an AC magnetic field excited by the antenna by demodulation and supplies a DC power source to each unit. Further, the communication unit 320 demodulates the modulating wave received via the antenna, and appropriately supplies the demodulated data to, for example, the control unit 310.

In a case where predetermined information is transmitted to the point reward device 200, the communication unit 320 modulates the data transmitted to the point reward device 200 based on, for example, changes in a load of the antenna, and transmits the modulating component to the point reward device 200 via the antenna.

The storage unit 330 of the IC card 300 includes, for example, a volatile semiconductor memory and a nonvolatile semiconductor memory. The storage unit 330 stores programs and data required for the control unit 310 to control each unit of the IC card 300, and also stores, for example, data from the point reward device 200 and data provided to the point reward device 200. Additionally, the storage unit 330 stores the points (or digital currency) in association with the passenger, i.e., in association with the authentication information corresponding to the passenger.

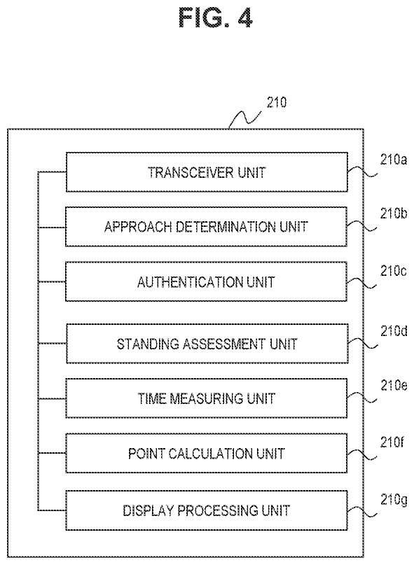

FIG. 4 is a schematic view illustrating functional blocks of the control unit 210 provided in the point reward device 200. The control unit 210 of the point reward device 200 includes a transceiver unit 210a, an approach determination unit 210b, an authentication unit 210c, a standing assessment unit 210d, a time measuring unit 210e, a point calculation unit 210f, and a display processing unit 210g. Each of these units included in the control unit 210 is, for example, a functional module implemented by a computer program executing by the control unit 210. In other words, each of these units included in the control unit 210 is configured by a program (software) for operating the control unit 210 and each of these units. Further, the program may be recorded in the storage unit 230 of the point reward device 200 or an external recording medium connected thereto. Alternatively, these units included in the control unit 210 may be dedicated arithmetic circuits provided in the control unit 210.

As described above, the components such as the control unit 210 and the storage unit 230 of the point reward device 200 may be provided on the server side, and in that case, the functional blocks of the control unit 210 shown in FIG. 4 are provided on the server side.

The transceiver unit 210a of the control unit 210 transmits/receives information to/from the IC card 300 via the communication unit 220. The transceiver unit 210a transmits a polling command to capture the IC card 300 being present in the vicinity of the point reward device 200. Further, the transceiver unit 210a receives the authentication information for verifying the IC card 300 from the IC card 300 via the communication unit 220, thereby authenticating the passenger. The transceiver unit 210a transmits the points calculated by the point calculation unit 210f to the storage unit 330 of the IC card 300. In particular, the transceiver unit 210a transmits the points calculated by the point calculation unit 210f to the storage unit 330 of the IC card 300 via the communication unit 220 of the point reward device 200 and the communication unit 320 of the IC card 300.

The approach determination unit 210b of the control unit 210 determines whether the IC card 300 is close to the point reward device 200 in a communicable state. For example, the approach determination unit 210b determines whether the IC card 300 is close to the point reward device 200 in a communicable state based on the load changes with respect to the predetermined electromagnetic wave emitted from the communication unit 220. The approach determination unit 210b may determine that the IC card 300 is close to the point reward device 200 in a case where a response to the transmitted data is received, for example, in a case where predetermined data is sequentially transmitted from the transceiver unit 210a to the IC card 300, and an acknowledgment (ACK) that the predetermined data is received is received from the IC card 300.

The authentication unit 210c of the control unit 210 authenticates the passenger based on the authentication information. In particular, the authentication unit 210c authenticates the passenger by verifying the authentication information stored in the IC card 300 owned by the passenger. For example, the authentication unit 210c compares the authentication information received from the IC card 300 with registration information previously enrolled in the storage unit 230, and authenticates the passenger in a case where the authentication information matches the registration information. On the other hand, the authentication unit 210c does not authenticate the passenger in a case where the authentication information does not match the registration information.

The standing assessment unit 210d of the control unit 210 assesses whether the authenticated passenger is standing up. In the present embodiment, the standing assessment unit 210d assesses that the authenticated passenger is standing up in a case where the IC card 300 of which the authentication information is verified is close to the communication unit 220 of the point reward device 200.

The time measuring unit 210e of the control unit 210 measures a period of time during which it is assessed that the authenticated passenger is standing up as a period of time during which the passenger is actually standing up.

The point calculation unit 210f of the control unit 210 is a calculation unit that calculates points that can be redeemed in the reward program, which calculates the points such that the authenticated passenger who stands up for a longer period of time gets more points.

The display processing unit 210g of the control unit 210 executes a process for displaying information on the display unit 240 of the point reward device 200. In particular, the display processing unit 210g executes, for example, a process for displaying the points transmitted to the IC card 300 on the display unit 240, or for displaying the current total points stored in the IC card 300 on the display unit 240.

When the transceiver unit 210a of the control unit 210 in the point reward device 200 transmits information on the points to the IC card 300, the communication unit 320 of the IC card 300 receives the information. The information on the points is demodulated by the communication unit 320 and then transmitted to the control unit 310.

The control unit 310 of the IC card 300 stores the points received from the point reward device 200 in a nonvolatile memory of the storage unit 330. At this time, in a case where the points are already stored in the storage unit 330 of the IC card 300, the control unit 310 adds the points received from the point reward device 200 to the already stored points, and stores the added points in the nonvolatile memory of the storage unit 330.

Further, the control unit 310 of the IC card 300 transmits information on the current total points stored in the nonvolatile memory of the storage unit 330 to the point reward device 200, if needed. As described above, the points thus transmitted are appropriately displayed on the display unit 240 of the point reward device 200.

When the points are stored in the storage unit 330 of the IC card 300, the passenger can redeem the points stored in the storage unit 330 of the IC card 300 in various reward programs. For example, the passenger can redeem the points for transportation tickets, goods, e-commerce, and the like. To promote further improvement of the health of passengers, the discount rate when the passenger redeems the points for purchase of healthcare products may be set to be larger than that of other products.

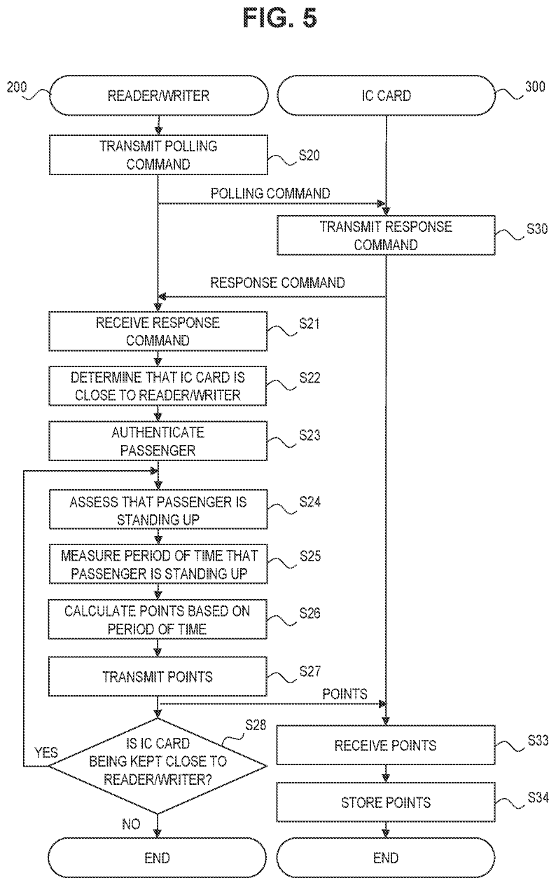

FIG. 5 is a sequence diagram illustrating a process executed by the system configured by the point reward device 200 and the IC card 300. First, the transceiver unit 210a of the control unit 210 in the point reward device 200 transmits a polling command via the communication unit 220 to attempt to establish the near-field wireless communication with the IC card 300 (step S20).

When the IC card 300 is close to the point reward device 200, the communication unit 320 of the IC card 300 receives the polling command, and the IC card 300 transmits a response command to the polling command to the point reward device 200 (step S30). The response command includes the authentication information of the IC card 300.

The transceiver unit 210a of the control unit 210 in the point reward device 200 receives the response command transmitted from the IC card 300 (step S21). The approach determination unit 210b of the control unit 210 determines that the IC card 300 is close to the point reward device 200 in a communicable state (step S22).

In a case where the IC card 300 is not close to the point reward device 200, the IC card 300 does not receive the polling command, whereby the response command is not transmitted to the point reward device 200. In a case where the response command is not received within a predetermined time, the point reward device 200 determines that the IC card 300 has not been recognized, and executes the process of step S20 again.

After step S22, the authentication unit 210c of the control unit 210 authenticates the passenger by verifying the authentication information included in the response command, based on the response command (step S23). The standing assessment unit 210d of the control unit 210 assesses that the authenticated passenger is standing up (step S24). The time measuring unit 210e of the control unit 210 measures a period of time (standing time) during which the passenger is standing up (step S25).

The point calculation unit 210f of the control unit 210 calculates points based on the period of time measured in step S25 (step S26). As described above, the point calculation unit 210f calculates the points such that the passenger gets more points as the period of time measured by the time measuring unit 210e is longer. The transceiver unit 210a transmits the calculated points to the IC card 300 via the communication unit 220 (step S27).

The communication unit 320 of the IC card 300 receives the points transmitted from the point reward device 200 (step S33). The control unit 310 of the IC card 300 stores the points transmitted from the point reward device 200 in the storage unit 330 (step S34). After step S34, the process of the IC card 300 is completed.

In the point reward device 200, after step S27, the approach determination unit 210b of the control unit 210 determines whether the IC card 300 is maintained in a state of being close to the point reward device 200 (step S28). In a case where the IC card 300 is maintained in a state of being close to the point reward device 200, the procedure returns to step S24, and the processes after step S24 are executed again. On the other hand, in a case where the IC card 300 is not maintained in a state of being close to the point reward device 200, the process of the point reward device 200 is terminated.

In the process shown in FIG. 5, the points are calculated after the passengers are authenticated, but the passengers may be authenticated after the points are calculated and before the points are transmitted. In this case, if the passenger cannot be authenticated, the points will not be transmitted.

According to the first embodiment as described above, it is assessed that the passenger 10 who owns the IC card 300 is standing up in a case where the IC card 300 is close to the point reward device 200 mounted on the strap handle 100, and the points are transmitted to the IC card 300 according to the period of time that the passenger 10 is standing up. Therefore, it is possible to encourage the passenger in the vehicle to stand up, thereby improving the health of the passenger.

### Second Embodiment

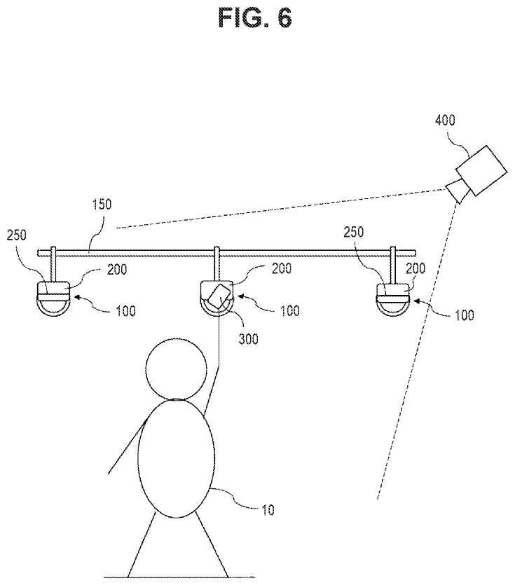

FIG. 6 is a schematic view illustrating the inside of the vehicle provided with the strap handle 100 and the point reward device 200 according to a second embodiment of the present disclosure. In the second embodiment, a camera 400 for capturing passengers is provided in the vehicle.

In the second embodiment, the passenger 10 is captured by the camera 400 installed in the vehicle, and it is assessed whether the passenger 10 is standing up based on a captured image. As in the first embodiment, verifying the authentication information stored in the IC card 300 authenticates the passenger. In a case where the passenger is standing up in the vicinity of the point reward device 200 that has authenticated the passenger, the points are transmitted to the IC card 300 of which the authentication information is verified.

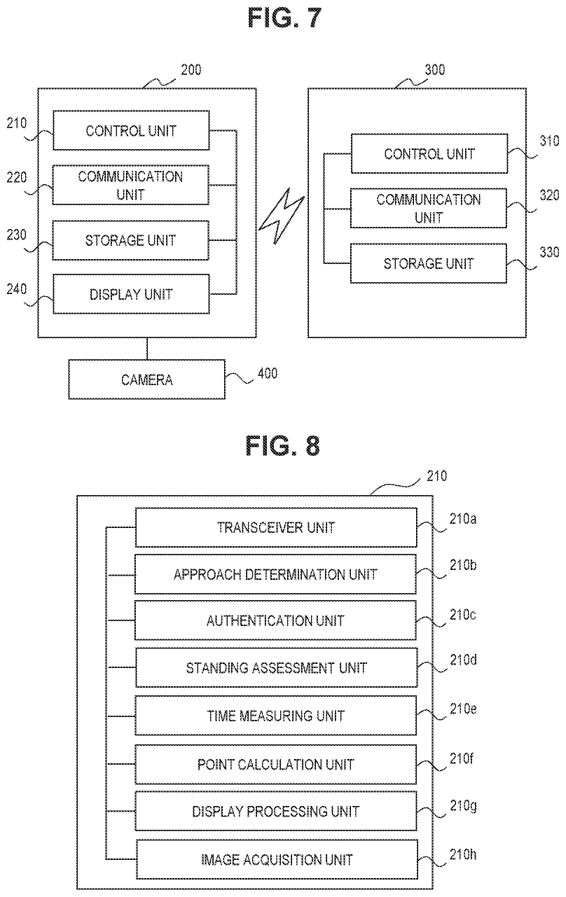

FIG. 7 is a block diagram illustrating a hardware configuration of the system configured by the point reward device 200 and the IC card 300 according to the second embodiment. In the system shown in FIG. 7, the camera 400 is added to the system shown in FIG. 3. The point reward device 200 and the camera 400 are communicably connected to each other via an in-vehicle network complying with a protocol such as the controller area network (CAN) or Ethernet®. The point reward device 200 and the IC card 300 are basically configured the same as the first embodiment shown in FIG. 3. In the second embodiment, the communication unit 220 of the point reward device 200 has a function of establishing communication with the camera 400 via the in-vehicle network, as well as a function of performing the near-field wireless communication complying with, for example, the NFC protocol.

The camera 400 is an in-vehicle camera, which has a 2D detector configured by an array of photoelectric conversion elements having sensitivity to visible light, such as CCD or C-MOS, and an imaging optical system that forms an image of a region corresponding to a detection target captured on the 2D detector. The camera 400 is provided on a ceiling or wall of the vehicle and is directed to a location in which the passenger 10 is likely to be present in the vicinity of the strap handle 100. The camera 400 captures the periphery of the strap handle 100 at predetermined shooting cycles (for example, 1/30 second to 1/10 second), and generates an image showing the passenger 10 around the strap handle 100. The camera 400 may be configured by a stereo camera, or may be configured to acquire a distance to each structure present in the image based on parallax between left and right images. Each time the camera 400 generates the image, the camera 400 outputs the generated image to the point reward device 200 via the in-vehicle network.

In the second embodiment, the storage unit 230 of the point reward device 200 stores information such as position information representing a 3D position of the point reward device 200 in the vehicle and internal parameters of the camera 400. The internal parameters contains information including information related to a mounting position and posture of the camera 400 in the vehicle, a focal length of the camera 400, and the like.

FIG. 8 is a schematic view illustrating functional blocks of the control unit 210 provided in the point reward device 200 according to the second embodiment. The control unit 210 of the point reward device 200 includes the transceiver unit 210a, the approach determination unit 210b, the authentication unit 210c, the standing assessment unit 210d, the time measuring unit 210e, the point calculation unit 210f, and the display processing unit 210g, which are described in the first embodiment, as well as an image acquisition unit 210h. Similar to the first embodiment, each of these units included in the control unit 210 is, for example, a functional module implemented by a computer program executing on the control unit 210. Hereinafter, each unit included in the control unit 210 will be described focusing on the differences from the first embodiment.

The image acquisition unit 210h of the control unit 210 acquires the image transmitted from the camera 400 via the in-vehicle network, which has been taken by the camera 400 in the vicinity of the communication unit 220 (authentication device). After the authentication unit 210c verifies the authentication information of the IC card 300, the standing assessment unit 210d of the control unit 210 assesses that the authenticated passenger is actually standing up, in a case where the standing passenger is shown within a predetermined range of distance from the point reward device 200, more specifically, a predetermined range of distance from the communication unit 220, in the image received from the camera 400. At this time, the standing assessment unit 210d inputs the image received from the camera 400 into a discriminator in which machine learning has been completed to detect the passenger and their posture, determines whether the passenger is shown in the image received from the camera 400, and then determines whether the passenger is standing up in a case where the passenger is shown in the image.

In particular, the standing assessment unit 210d determines whether the standing passenger is included in a predetermined range of distance (for example, directly below the point reward device 200) from the point reward device 200 in the image, based on the position information of the point reward device 200 stored in the storage unit 230 and the camera parameters. For example, the standing assessment unit 210d obtains a conversion equation from a camera coordinate system having the position of the camera 400 as the origin and the optical axis direction of the camera 400 as one axial direction into a coordinate system inside the vehicle. Such a conversion equation is represented by a combination of a rotation matrix representing rotation between the coordinate systems and a translation vector representing translation between the coordinate systems. The standing assessment unit 210d converts the position of the passenger included in the image represented by the camera coordinate system into coordinates of the vehicle coordinate system according to the conversion equation. The standing assessment unit 210d compares the position of the point reward device 200 represented by coordinates of the vehicle coordinate system with the position of the passenger, determines whether the passenger is shown within the predetermined range of distance from the point reward device 200, and then determines whether the passenger is standing up in a case where the passenger is shown within the predetermined range.

Further, the standing assessment unit 210d may be configured to recognize the passenger's face from the image by inputting the image received from the camera 400 into the discriminator in which machine learning has been completed for face detection. In this case, the standing assessment unit 210d may be configured to track the passenger in the image based on the recognized face once it is assessed that the authenticated passenger is standing up, regardless of whether the passenger standing within the predetermined range of distance from the point reward device 200 is shown, determine whether the passenger is standing up in the image, and then assess that the passenger is actually standing up in a case where the passenger is standing up in the image.

The standing assessment unit 210d can employ, for example, a neural network (NN) such as FasterR-CNN, YOLO or SSD, as the discriminator, which simultaneously classifies objects and detects a position of a bounding box. Further, the standing assessment unit 210d can employ the discriminator stated above, for example, a segmentation discriminator that has been trained so as to output the certainty that a certain object is represented by a certain pixel from the input image, for each pixel of the image and for each type of object that may be represented by the pixel, thereby identifying that the object having the maximum certainty is shown in the image. The standing assessment unit 210d can employ a deep neural network (DNN) having a convolutional neural network (CNN) architecture for segmentation, for example, a fully convolutional network (FCN), as such a discriminator. Alternatively, the standing assessment unit 210d may use a segmentation discriminator according to another machine learning algorithm such as a random forest or a support vector machine. In this case, the standing assessment unit 210d inputs the image into the segmentation discriminator to identify a pixel in which any object appears in the image. The standing assessment unit 210d sets a set of pixels in which an object of the same type appears, as a region in which the object is represented.

Moreover, the standing assessment unit 210d performs, for example, template matching between a template image in which a person is represented and the image received from the camera 400, determines whether the passenger is shown in the image received from the camera 400, and then determines whether the passenger is standing up in a case where the passenger is shown in the image.

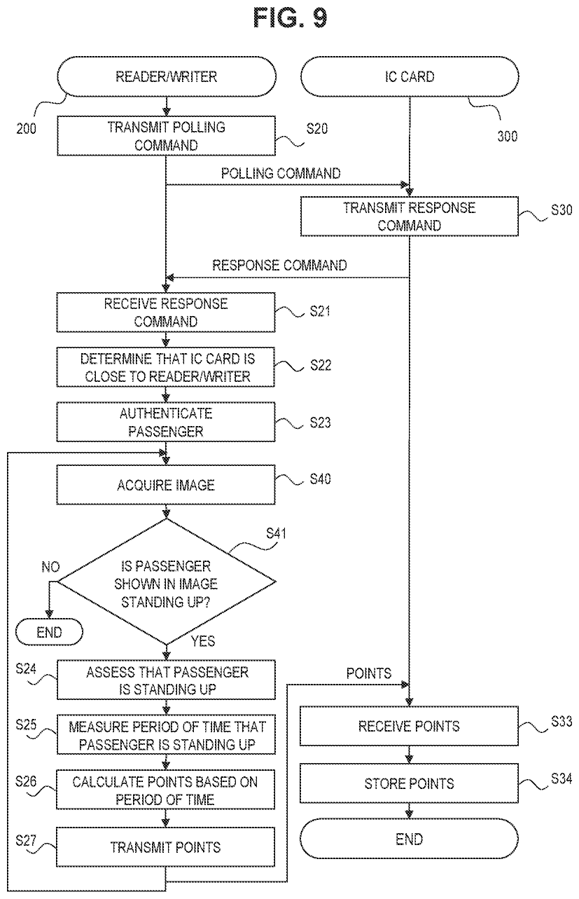

FIG. 9 is a sequence diagram illustrating a process executed by the system configured by the point reward device 200 and the IC card 300 according to the second embodiment. Compared with the process of FIG. 5 described in the first embodiment, the process shown in FIG. 9 has additional steps S40 and S41 while removing step S28 of FIG. 5. Hereinafter, elements different from the first embodiment as shown in FIG. 5 will be mainly described.

When the authentication unit 210c of the control unit 210 authenticates the passenger by verifying the authentication information of the IC card 300 in step S23, the image acquisition unit 210h of the control unit 210 acquires the image transmitted from the camera 400 via the in-vehicle network (step S40). The standing assessment unit 210d determines whether the standing passenger is shown within a predetermined range of distance from the communication unit 220 of the point reward device 200 in the image (step S41). In a case where the standing passenger is shown within the predetermined range of distance from the communication unit 220 of the point reward device 200, the standing assessment unit 210d assesses that the authenticated passenger is actually standing up (step S24).

On the other hand, in a case where the standing passenger is not shown within the predetermined range of distance from the communication unit 220 of the point reward device 200 in step S41, the standing assessment unit 210d assesses that the authenticated passenger is not actually standing up, and the subsequent process is terminated.

The process after step S24 is basically the same as that of the first embodiment, but in the second embodiment it is assessed that the passenger is actually standing up based on whether that standing passenger is shown in the image. Therefore, the procedure returns to step S40 after step S27 without executing the process of step S28 of the first embodiment shown in FIG. 5. Whether the passenger is standing up is assessed again based on the image.

In the process of FIG. 9, it is not necessary to execute the process of step S22 because it is not assessed whether the passenger is standing up based on the IC card 300 being present in the vicinity of the point reward device 200.

As described above, according to the process of FIG. 9, in a case where the standing passenger is shown within the predetermined range of distance from the communication unit 220 of the point reward device 200 in the image, it is assessed that the authenticated passenger is actually standing up, and the points are transmitted to the IC card 300 according to the period of time that the passenger is standing up. On the other hand, in a case where the standing passenger is not shown within the predetermined range of distance from the communication unit 220 of the point reward device 200 in the image, it is assessed that the authenticated passenger is not actually standing up, and the points are not transmitted to the IC card 300.

Whether the passenger is standing up is assessed based on the image, not based on the IC card 300 being present in the vicinity of the point reward device 200. Therefore, the passenger does not have to keep the IC card 300 close to the point reward device 200 after the passenger is authenticated in step S23.

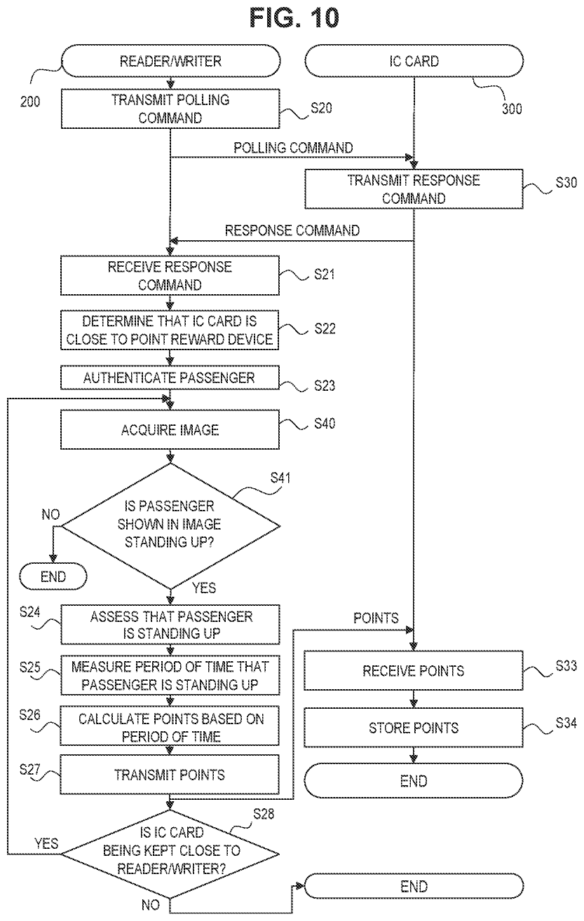

In the description stated above, the standing assessment unit 210d of the control unit 210 estimates that the passenger is standing up based on the image captured by the camera 400. Meanwhile, the standing assessment unit 210d may assess that the authenticated passenger is standing up based on both the image received from the camera 400 and the IC card 300 being present in the vicinity of the point reward device 200. FIG. 10 is a sequence diagram illustrating a process in this case. In FIG. 10, steps S40 and S41 are added as the processes of the point reward device 200 to the sequence diagram of FIG. 5 described in the first embodiment. In FIG. 10, the processes other than steps S40 and S41 are basically the same as those of the first embodiment. Therefore, the differences from those of the first embodiment will be mainly described hereinbelow.

When the authentication unit 210c of the control unit 210 authenticates the passenger by verifying the authentication information of the IC card 300 in step S23, the image acquisition unit 210h of the control unit 210 acquires the image transmitted from the camera 400 via the in-vehicle network (step S40). The standing assessment unit 210d determines whether the standing passenger is shown within a predetermined range of distance from the communication unit 220 of the point reward device 200 in the image (step S41). In a case where the standing passenger is shown within the predetermined range of distance from the communication unit 220 of the point reward device 200, the standing assessment unit 210d assesses that the authenticated passenger is actually standing up (step S24). The process after step S24 is the same as that of the first embodiment.

On the other hand, in a case where the standing passenger is not shown within the predetermined range of distance from the communication unit 220 of the point reward device 200 in step S41, the standing assessment unit 210d assesses that the authenticated passenger is not actually standing up, and the subsequent process is terminated.

As described above, according to the process of FIG. 10, in a case where the IC card 300 in a communicable state is close to the communication unit 220, and the standing passenger is shown within the predetermined range of distance from the communication unit 220 of the point reward device 200 in the image, it is assessed that the authenticated passenger is actually standing up. Therefore, the presumption as to whether the passenger is standing up is more reliable.

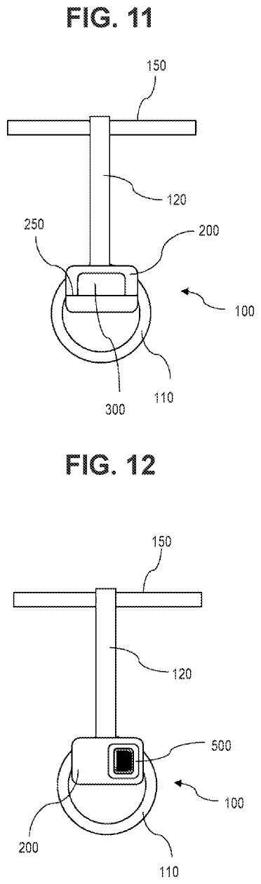

FIG. 11 is an enlarged schematic view illustrating the strap handle 100, the point reward device 200, and the periphery thereof, which shows an example in which a holder 250 of IC card 300 is provided in the point reward device 200.

The holder 250 is in, for example, a shape of a bag, and the IC card 300 can be inserted into the holder 250 from above. When the IC card 300 is inserted into the holder 250, the IC card 300 is held in the holder 250 while the IC card 300 is close to the point reward device 200.

When the IC card 300 is inserted into the holder 250, it is not necessary for the passenger to bring the IC card 300 close to the point reward device 200 while they hold the strap handle 100, whereby the passenger can earn the points on the IC card 300 with less of a burden.

On the other hand, as in the first embodiment, in a case where it is assessed that the passenger is standing up based on the IC card 300 that is close to the point reward device 200 in a communicable state and the points are transmitted to the IC card 300 of the passenger, the points are unfairly given to the IC card 300 even when the passenger 10 is seated while the IC card 300 remains in the holder 250.

In the second embodiment, it is assessed whether the passenger 10 who owns the IC card 300 is standing up based on the image captured by the camera 400. Therefore, in a case where the passenger 10 is seated while the IC card 300 remains in the holder 250, it is assessed that the authenticated passenger is not standing up, and the points are not transmitted to the IC card 300. Consequently, it is possible to provide the holder 250 of the IC card 300 in the point reward device 200, which enhances the convenience of passengers.

As described above, according to the second embodiment, in a case where the standing passenger is shown within the predetermined range of distance from the point reward device 200 that has authenticated the passenger in the image received from the camera 400, it is assessed that the authenticated passenger is actually standing up, and the points are transmitted to the IC card 300. Therefore, it is possible to encourage the passenger in the vehicle to stand up, thereby improving the health of the passenger.

### Modified Example 1

In the embodiment stated above, the passenger is authenticated by verifying the authentication information of the IC card 300, but the passenger authentication is not limited thereto. The authentication unit 210c of the control unit 210 in the point reward device 200 may authenticate the passenger by other authentication algorithms, e.g. biometric authentication such as vein authentication, fingerprint authentication, and face authentication.

FIG. 12 is an enlarged schematic view illustrating the strap handle 100, the point reward device 200, and the periphery thereof, similar to FIG. 2, which shows an example in which a biometric information acquisition device 500 is mounted on the strap handle 100 together with the point reward device 200. The biometric information acquisition device 500 acquires the passenger's biometric information when the passenger holds out their hand over the biometric information acquisition device 500. In particular, the biometric information acquisition device 500 is a camera, which captures veins or fingerprints of the passenger's hand to acquire the biometric information. In a case of the face authentication, the biometric information acquisition device 500 acquires the biometric information by capturing the passenger's face. In a case of the fingerprint authentication, the biometric information acquisition device 500 may be a capacitance fingerprint sensor.

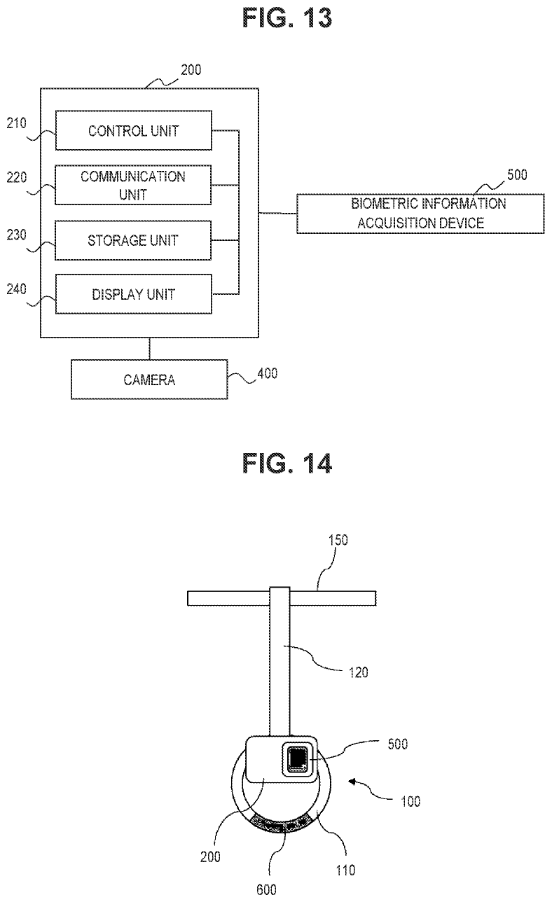

FIG. 13 is a block diagram illustrating a hardware configuration of the point reward device 200 according to Modified Example 1, and a peripheral configuration of the point reward device 200. As shown in FIG. 13, the point reward device 200 is communicably connected to the camera 400 via the in-vehicle network as in the second embodiment, and may be further communicably connected to the biometric information acquisition device 500 via the in-vehicle network. A basic configuration of the point reward device 200 is the same as that of the second embodiment, but in Modified Example 1, the communication unit 220 does not need to have a function of performing near-field communication complying with, for example, the NFC protocol. Therefore, the point reward device 200 according to Modified Example 1 does not need to have a function of the reader/writer.

A basic configuration of the functional blocks of the control unit 210 provided in the point reward device 200 according to Modified Example 1 is the same as that of the second embodiment described with reference to FIG. 8. Hereinafter, the description will be made focusing on the differences from the second embodiment. Whether the passenger is standing up is assessed based on the image received from the camera 400, not based on the IC card 300 being present in the vicinity of the point reward device 200. Therefore, the approach determination unit 210b does not have to be provided.

In a case of performing biometric authentication such as vein authentication, fingerprint authentication, and face authentication, the transceiver unit 210a of the control unit 210 in the point reward device 200 receives the biometric information of veins, fingerprints, or face from the biometric information acquisition device 500 as the authentication information for verifying the passenger. The authentication unit 210c of the control unit 210 in the point reward device 200 compares registration information for vein, fingerprint, or face authentication, which has been registered for each passenger, with the authentication information received from the biometric information acquisition device 500, thereby verifying the passenger. The registration information for vein, fingerprint, or face authentication is registered in advance and stored in the storage unit 230 of the point reward device 200.

After the authentication unit 210c verifies the passenger with the biometric authentication, the standing assessment unit 210d of the control unit 210 in the point reward device 200 assesses that the authenticated passenger is actually standing up in a case where the standing passenger is shown within a predetermined range of distance from the biometric information acquisition device 500 transmitting the authentication information, based on the image received from the camera 400.

In Modified Example 1, since the passenger does not have the IC card 300, the points given to the passenger are stored in the point reward device 200. Accordingly, the storage unit 230 of the point reward device 200 stores the points in association with each of the plurality of passengers. For example, the storage unit 230 stores the biometric information (authentication information) of the passengers and the points associated with the passengers in combination for each of the passengers. The transceiver unit 210a of the control unit 210 in the point reward device 200 transmits the points to the storage unit 230 in association with the authenticated passenger (i.e. in association with the authentication information). The passengers can redeem the points stored in the storage unit 230 in association with themselves.

With such a configuration, it is possible to verify the passenger with other authentication algorithms, for example, biometric authentication such as vein authentication, fingerprint authentication, or face authentication, and to transmit the points to the storage unit 230 that stores the points in association with the passenger in a case where the authenticated passenger is standing up.

### Modified Example 2

In Modified Example 1, whether the passenger is standing up may be assessed based on whether the passenger's hand is touching a touch sensor attached to the strap handle 100. FIG. 14 is an enlarged schematic view illustrating the strap handle 100, the point reward device 200, and the periphery thereof, similar to FIG. 12, which shows an example in which a touch sensor 600 is mounted on the strap handle 100 as well as the point reward device 200 and the biometric information acquisition device 500. The touch sensor 600 is configured by, for example, a capacitance or pressure sensitive sensor.

As shown in FIG. 14, the touch sensor 600 is mounted on the hanging ring 110. With such a configuration, when the passenger's hand grabs the hanging ring 110, the passenger's hand touches the touch sensor 600, whereby a signal indicating that their hand grabs the hanging ring 110 is output from the touch sensor 600.

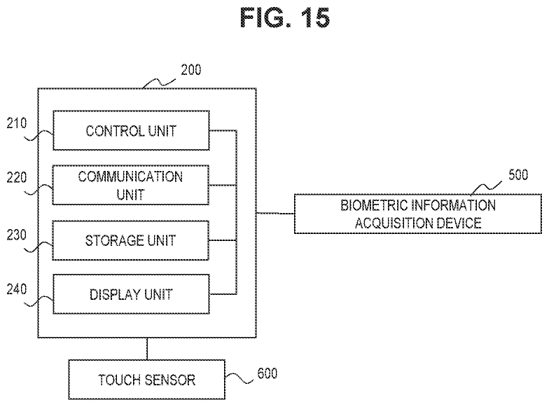

FIG. 15 is a block diagram illustrating a hardware configuration of the point reward device 200 according to Modified Example 2, and a peripheral configuration of the point reward device 200. As shown in FIG. 15, the point reward device 200 is communicably connected to the biometric information acquisition device 500 via the in-vehicle network as in Modified Example 1, and may be further communicably connected to the touch sensor 600 via the in-vehicle network. Modified Example 2 shown in FIG. 15 is distinct from Modified Example 1 in that the touch sensor 600 is provided instead of the camera 400 of Modified Example 1. A basic configuration of the point reward device 200 is the same as that of Modified Example 1.

A basic configuration of the functional blocks of the control unit 210 provided in the point reward device 200 according to Modified Example 2 is the same as that of the first embodiment, thus the differences from the first embodiment will be mainly described hereinbelow. Whether the passenger is standing up is assessed based on the output from the touch sensor 600, not based on the IC card 300 being present in the vicinity of the point reward device 200. Therefore, the approach determination unit 210b does not have to be provided.

Similar to Modified Example 1, the transceiver unit 210a of the control unit 210 in the point reward device 200 receives the biometric information of veins, fingerprints, or face from the biometric information acquisition device 500 as the authentication information for verifying the passenger. The authentication unit 210c of the control unit 210 in the point reward device 200 compares registration information for vein, fingerprint, or face authentication, which has been registered for each passenger, with the authentication information received from the biometric information acquisition device 500, thereby verifying the passenger.

The standing assessment unit 210d of the control unit 210 in the point reward device 200 assesses that the authenticated passenger is actually standing up in a case where the passenger's hand touches the touch sensor 600, based on the signal received from the touch sensor 600.

Similar to Modified Example 1, the transceiver unit 210a of the control unit 210 in the point reward device 200 transmits the points to the storage unit 230 in association with the authenticated passenger, based on the authentication information.

In Modified Examples 1 and 2, the passenger who has earned the points may perform, for example, the same authentication as described above when they want to redeem the points, and redeem the points stored in the storage unit 230 in association with their own biometric information. Therefore, in Modified Examples 1 and 2, the components such as the control unit 210 and the storage unit 230 of the point reward device 200 may be provided on a server outside the vehicle.

In the first and second embodiments, the transceiver unit 210a transmits the points to the IC card 300 in association with the authentication information. Meanwhile, in Modified Examples 1 and 2, the transceiver unit 210a transmits the points to the storage unit 230 in association with the authenticated passenger (i.e., in association with the authentication information). Summarizing these embodiments and modified examples, the transceiver unit 210a transmits the points to a storage unit which stores the points in association with the passenger. The storage unit is provided on a communication device, such as the IC card 300, or a server.

What is claimed is:

1. An information processing apparatus comprising:
a receiving unit configured to receive authentication information for authenticating a passenger in a vehicle;
an authentication unit configured to authenticate a passenger based on the authentication information;
an assessment unit configured to assess whether the authenticated passenger is standing up;
a measuring unit configured to measure a period of time during which the assessment unit assesses that the authenticated passenger is standing up as a period of time during which the passenger is actually standing up;
a calculation unit configured to calculate points or digital currency used in a reward program, the calculation unit calculating the points or the digital currency such that an authenticated passenger who stands up for a longer period of time gets more points or a higher amount of digital currency; and
a transmission unit configured to transmit the calculated points or digital currency to a storage unit, the storage unit being configured to store the points or the digital currency in association with the passenger.

2. The information processing apparatus according to claim 1, wherein:
the receiving unit is configured to receive the authentication information from an authentication device installed inside the vehicle, the authentication device being configured to authenticate the passenger;
the information processing apparatus further includes an image acquisition unit configured to acquire an image taken in a vicinity of the authentication device; and
the assessment unit is configured to assess that the authenticated passenger is standing up in a case where the image shows the passenger standing up within a predetermined range of distance from the authentication device.

3. The information processing apparatus according to claim 1, wherein:
the receiving unit is configured to receive the authentication information from an authentication device installed inside the vehicle and establishing short-range wireless communication with a communication device, the communication device being owned by the passenger and including the storage unit;
the authentication unit is configured to authenticate the passenger by verifying the authentication information stored in the communication device; and
the transmission unit is configured to transmit the calculated points or digital currency to the storage unit of the communication device.

4. The information processing apparatus according to claim 3, further comprising:
a determination unit configured to determine whether the communication device is in a communicable state with and is close to the authentication device installed at a height at which the passenger is able to bring the passenger's hands closer to the authentication device when the passenger stands up in the vehicle,
wherein the assessment unit is configured to assess that the authenticated passenger is standing up in a case where the communication device is in a communicable state with and is close to the authentication device.

5. The information processing device according to claim 3, further comprising:
an image acquisition unit configured to acquire an image taken in a vicinity of the authentication device,
wherein the assessment unit is configured to assess that the authenticated passenger is standing up in a case where the image shows the passenger standing up within a predetermined range of distance from the authentication device.

6. The information processing apparatus according to claim 5, further comprising:
a determination unit configured to determine whether the communication device is in a communicable state with and is close to the authentication device installed at a height at which the passenger is able to bring the passenger's hands closer to the authentication device when the passenger stands up in the vehicle,
wherein the assessment unit is configured to assess that the authenticated passenger is standing up in a case where the communication device is in a communicable state with and is close to the authentication device and the image shows the passenger standing up within the predetermined range of distance from the authentication device.

7. The information processing apparatus according to claim 3, wherein the communication device is an IC card or a portable terminal.

8. The information processing apparatus according to claim 2, wherein:
the authentication device is a biometric information acquisition device that acquires biometric information of the passenger;
the authentication information is the biometric information of the passenger acquired by the biometric information acquisition device; and
the authentication unit is configured to authenticate the passenger based on the biometric information.

9. The information processing apparatus according to claim 1, wherein:
the receiving unit is configured to receive the authentication information from an authentication device installed inside the vehicle, the authentication device being configured to authenticate the passenger;
the authentication device is a biometric information acquisition device that acquires biometric information of the passenger;
the authentication information is the biometric information of the passenger acquired by the biometric information acquisition device;
the authentication unit is configured to authenticate the passenger based on the biometric information; and
the assessment unit is provided in a vicinity of the biometric information acquisition device and is configured to assess whether the authenticated passenger is standing up based on an output from a touch sensor installed at a height at which the passenger is able to bring the passenger's hands closer to the authentication device when the passenger stands up.

10. The information processing apparatus according to claim 8, wherein the transmission unit is configured to transmit points or digital currency in association with the authenticated passenger to the storage unit which is configured to store points or digital currency in association with each of a plurality of passengers, based on the authentication information.

11. The information processing apparatus according to claim 2, wherein the authentication device is provided on a strap handle in the vehicle.

12. An information processing system that includes a communication device owned by a passenger in a vehicle and an information processing apparatus connected to and wirelessly communicating with the communication device, the information processing system comprising:
a receiving unit configured to receive authentication information for authenticating a passenger in the vehicle;
an authentication unit configured to authenticate a passenger based on the authentication information;
an assessment unit configured to assess whether the authenticated passenger is standing up;
a measuring unit configured to measure a period of time during which the assessment unit assesses that the authenticated passenger is standing up as a period of time during which the passenger is actually standing up;
a calculation unit configured to calculate points or digital currency used in a reward program, the calculation unit calculating the points or digital currency such that the authenticated passenger who stands up for a longer period of time gets more points or a higher amount of digital currency; and
a transmission unit configured to transmit the calculated points or digital currency to a storage unit of the communication device, the storage unit being configured to store the points or the digital currency in association with the passenger.
